(19) United States
(12) Patent Application Publication
(10) Pub. No.: US 2019/0087920 A1
(43) Pub. Date: Mar. 21, 2019

(54) POWER TRADING SYSTEM

(71) Applicant: HEPU Technology Development (Beijing) Co. LTD., Beijing (CN)

(72) Inventors: HUA CUI, BEIJING (CN); YUSEN YANG, BEIJING (CN); BO XU, BEIJING (CN); ZHI TAN, BEIJING (CN); HUI CHEN, BEIJING (CN)

(73) Assignee: HEPU Technology Development (Beijing) Co. LTD., Beijing (CN)

(21) Appl. No.: 16/103,595

(22) Filed: Aug. 14, 2018

(30) Foreign Application Priority Data
Sep. 20, 2017 (CN) 201710855193.2
Nov. 10, 2017 (CN) 201711107184.1
Nov. 10, 2017 (CN) 201711107876.6

(51) Int. Cl. G06Q 50/06; G06Q 40/04; H04L 9/32; G06Q 20/38; G06Q 20/06

(52) U.S. Cl. CPC G06Q 50/06; G06Q 40/04; H04L 9/3236; H04L 2209/56; H04L 9/3255; G06Q 20/065; G06Q 20/3829

(57) ABSTRACT

The present invention discloses a power trading system, comprising: a measurement module, a block chain module and a communication module. The measurement module is configured to bidirectionally or unidirectionally measure a power amount; the block chain module uses the communication module and an Internet-based block chain network to realize peer-to-peer power trading among nodes within the block chain network in a region; and the communication module is configured to, by using the wireless or wired communication technology, transmit data between the measurement module and the block chain module, and transmit data in the block chain network.

### CROSS-REFERENCE TO RELATED APPLICATIONS

This application claims the benefit of priority to Chinese Patent Application No. 201710855193.2, No. 201711107876.6 and No. 201711107184.1, titled “Blockchain-based Power Trading System”, “Intelligent Power Meter” and “Energy Internet Router” respectively, and filed with the Chinese State Intellectual Property Office on Sep. 20, 2017, Nov. 10, 2017 and Nov. 10, 2017, respectively, the entire disclosure of which is incorporated herein by reference.

### FIELD OF THE INVENTION

The present invention relates to the field of measurement control of Internet of things and energy Internet as well as block chain technologies, and more particularly, to a power trading system.

### BACKGROUND OF THE INVENTION

A super-huge network, specifically a power grid, is formed naturally from power generation, power transmission, power distribution to power utilization by virtue of the uniqueness of an electrical power system. At one end of this network, there are traditional energy including coal energy, gas energy, nuclear power energy, hydro energy and electrical energy as well as distributed renewable energy such as wind energy and solar energy. At the other end of the network, there are millions of high energy-consuming power devices, hundreds of millions of electrical power users as well as smart home appliances and electrical automobiles coming in the future. A wide variety of sensors all over China will generate massive real-time big data every minute, every millisecond, and even every microsecond; thus a huge energy Internet is created.

Data sources of the energy Internet mainly come from the following aspects: (1) coal-fired thermal power plants; (2) natural gas power plants; (3) wind farm and photovoltaic power plants; (4) natural gas-based distributed energy systems with combined cooling, heating and power; (5) distributed wind-solar energy storage battery grids; (6) various levels of smart transformer substations; (7) SCADAs (Supervisory Control and Data Acquisition Systems) in provinces/municipalities/counties; (8) hundreds of millions of smart power meters; (9) millions of high energy-consuming power devices; and (10) future electrical automobiles. In the future, a larger number of distributed wind power energy and photovoltaic systems and storage batteries will emerge.

The energy Internet will greatly promote the development of distributed energy in the future. At the power supply side, with the installation of a great quantity of renewable energy, random fluctuation of power supplies is a major challenge for a power system. The randomness and the rigidity at the load side will be increasingly high due to changes of an electrical power consumption structure and rapid development of the electrical automobiles. In addition, along with the emergence of energy producer-consumer buildings in the further, distributed measurement and trading of energy will become the mainstream. However, a traditional centralized power grid control mode and a unified power meter data collection manner in a power grid will face great challenges in the future.

An power trading system in the prior art cannot collect, trade, settle or record a power amount in distributed wind power energy and photovoltaic systems and storage batteries, and thus cannot meet the requirements of big data in the energy Internet.

### SUMMARY OF THE INVENTION

### I. Objects of the Present Invention

An object of the present invention is to provide a power trading system which adopts a block chain module to solve the problem that the power trading system in the prior art cannot collect, trade, settle or record a power amount in distributed wind power energy and photovoltaic systems and storage batteries, and thus cannot meet the requirements of big data in the energy Internet. Thus, a power generation amount and a power consumption amount of distributed power generation systems, power storage systems and electrical power users can be measured, so that the power amount in a dispersed smart grid can be measured, traded, settled and recorded. Smart power meters at a distributed power generation side and power consumption side serve as a charge basis in trading.

### II. Technical Solutions

To solve the above problem, the present invention provides a power trading system, comprising: a measurement module, a block chain module, and a communication module. The measurement module is configured to bidirectionally or unidirectionally measure a power amount; the block chain module uses the communication module and an Internet-based block chain network to realize peer-to-peer power trading, settling among nodes within the block chain network in a region; and the communication module is configured to, by using the wireless or wired communication technology, transmit data between the measurement module and the block chain module, and transmit data in the block chain network. In the power trading system, the block chain module is provided for power trading and recording, so that final power amount information and peer-to-peer power trading information are stored in the block chain network in a distributed and immutable manner. Therefore, a power generation amount and a power consumption amount of distributed power generation systems, power storage systems and electrical power users can be measured, so that the power amount in a dispersed smart grid can be measured, traded, settled and recorded.

Further, the power trading system further comprises: a block chain power meter. The measurement module, the block chain module and the communication module are arranged in the block chain power meter. A central processor is further arranged in the block chain power meter. The measurement module is connected to the central processor. The block chain module interacts with the central processor in data. The communication module is connected to the central processor and is configured to transmit data between the measurement module and the block chain module, and transmit data in the block chain network.

Further, the block chain module further comprises: a positioning unit which is connected to the central processor in the block chain power meter and which is configured to position a geographical location of the block chain power meter.

Further, the block chain module is further configured to assign each block chain power meter with a unique ID to form a node with the unique ID in the block chain network.

Further, the power trading system further comprises: a conventional power meter and an energy Internet router. The measurement module and the communication module are arranged in the conventional power meter. The block chain module and the communication module are arranged in the energy Internet router. The communication module is configured to transmit data between the measurement module in the conventional power meter and the block chain module in the energy Internet router, and transmit data in the block chain network.

Further, the energy Internet router further comprises: a control module and an acquisition module. The control module is configured to control energy exchange between a plurality of distributed energy stations and a plurality of distributed energy users, routing management and peer-to-peer power trading within the same local area network. The acquisition module is connected to the control module and is configured to acquire measured power amount data of the conventional power meter. The block chain module interacts with the control module in data. The communication module is connected to the control module.

Further, the block chain module further comprises: a positioning unit which is connected to the control module in the energy Internet router and which is configured to position a geographical location of the energy Internet router.

Further, the block chain module is further configured to assign each energy Internet router with a unique ID to form a node with the unique ID in the block chain network.

Further, the block chain module is provided with a data layer for storing the following data: measured power amount data measured by the measurement module; power amount trading data which is all peer-to-peer power trading data in the block chain network; a power purchasing and selling identifier which is configured to distinguish a power purchaser from a power seller; and a timestamp for recording peer-to-peer power trading time in the block chain network. The data layer is further configured to add a timestamp onto power purchasing and selling trading data in each node to form a data block which is recorded in the block chain network and is immutable.

Further, the power purchasing and selling identifier refers to a binary character string having a predetermined meaning. A first set value of the binary character string represents that a current node is the power seller; and a second set value of the binary character string represents that a current node is the power purchaser.

Further, the data layer comprises an encryption management unit which encrypts data through hardware or software and which is configured to manage private key information of a user. The data layer further comprises one or a combination of a data block, a hash, Merkle tree root data, a peer-to-peer network, key management, public and private key's, asymmetric encryption and a verification mechanism.

Further, the block chain module is further provided with a contract consensus layer for automatically confirming power trading between the power purchaser and the power seller within the range of the block chain network through a smart contract, the power trading content comprising a power trading price, a power trading amount and a trading condition.

Further, the contract consensus layer comprises one or a combination of an account center unit, a power purchasing and selling registration unit, a power purchasing and selling price matching unit, a power purchasing and selling trading realization unit, a consensus mechanism unit, a smart contract unit, a script code unit and a payment system unit.

Further, the block chain module uses a digital currency for power trading or settlement.

Further, the block chain network is a public chain, a private chain, or an alliance chain. All or part of nodes of the public chain, the private chain or the alliance chain have complex authorities of reading, writing and keeping accounts.

Further, the communication module is one or a combination of an RS485 communication module, an RFID module, a Bluetooth module, a WIFI module, a power line carrier module, a 3G network module, a 4G network module, a 5G network module and an Internet module.

### III. Beneficial Effects

The above technical solutions of the present invention have the following beneficially technical effects.

In the power trading system provided by the present invention, the block chain module is provided for power trading, settling and recording, so that final power amount information and peer-to-peer power trading information are stored in the block chain network in a distributed and immutable manner. Through the power trading system provided by the present invention, a power generation amount and a power consumption amount of distributed power generation systems, power storage systems and electrical power users can be measured, so that the power amount in a dispersed smart grid can be measured, traded, settled and recorded. The block chain power meter or the conventional power meter at the distributed power generation side and power consumption side serve as a charge basis in trading. Meanwhile, people can intelligently manage and monitor their own distributed power generation, storage and consumption facilities by using various mobile terminals.

### BRIEF DESCRIPTION OF THE DRAWINGS

FIG. 1 is a schematic architecture view of a power trading system provided by the present invention;

FIG. 2 is a schematic component view of a power trading system according to a first embodiment of the present invention;

FIG. 3 is a component view of a block chain power meter according to a second embodiment of the present invention;

FIG. 4 is a schematic component view of a power trading system according to a third embodiment of the present invention;

FIG. 5 is a component view of an energy Internet router according to a fourth embodiment of the present invention; and

FIG. 6 is a schematic component view of a power trading system according to a fifth embodiment of the present invention.

Description of reference numerals: 100: block chain power meter; 101, 301: central processor; 102, 302: measurement module; 103, 403: block chain module; 1031, 4031: data layer; 1032, 4032: network layer; 1033, 4033: contract consensus layer; 104, 303, 404: communication module; 105, 304: digital signal module; 106, 305: protocol interface module; 107, 306: power supply module; 108, 307: display module; 109, 308: clock module; 200: block chain network; 300: conventional power meter; 400: energy Internet router; 401: control module; 402: acquisition module; and 405: power electronic conversion and energy storage module.

### DETAILED DESCRIPTION OF THE INVENTION

In order to explain the objects, technical solutions and advantages of the present invention more apparently, the present invention is further described in detail below with reference to the specific embodiments and accompanying drawings. It should be understood that these descriptions are merely exemplary and are not intended to limit the scope of the present invention. In addition, in the following description, descriptions of well-known structures and techniques are omitted to avoid unnecessarily obscuring the concepts of the present invention.

Technologies related to the block chain technology will be introduced first before describing a power trading system provided by the present invention in detail.

Bitcoin appeared in 2009 brought about a disruptive outcome the block chain technology. A block chain is a secure account book-like database consisting of data blocks. Users can look for data in this block chain network which is continuously updated and upgraded. For financial institutions, the block chain can speed up a trading processing process, lower a cost, reduce the number of middlemen, improve market insight, and increase business transparency.

The block chain technology, as the underlying technology of the crypto currency Bitcoin, is a great innovation. The block chain technology can be used to combat fraud and illegal trading, and many industries are using the block chain technology. Particularly, the energy Internet technologies are also using the block chain technology as a tool. The block chain technology has the following functions. First, the fair block chain-based data ensures credibility, and the combined public and private key access authorization protects privacy, realizing complete privacy and credible calculation. Second, the block chain technology prevents falsification as subjects adopt a certain way to realize cooperative or compulsory trust, so as to achieve ubiquitous interaction under compulsory trust. Third, the block chain, big data and artificial intelligence technologies are combined to form a trustworthy oracle model to verify external data, so that self-discipline of virtual reality interaction is realized. Fourth, devices allocated based on the block chain technology make decisions in a peer-to-peer interactive manner, and do not need to entrust a centralized platform to make decisions, so that device democracy and distributive decision-making are realized by decentralization. Fifth, the subjects carry out stochastic game based on clear interaction rules, so that the system presents a neutral or benign evolution, thereby meeting the marketization law as well as the coordination and evolvability in competition evolution.

The block chain technology not only can realize disintermediation, but also may disrupt the market and existing value chains, and may create a new market by releasing undeveloped supply vitality. The combination of the block chain technology and an energy Internet measurement system will provide reliable technical support for future development of the energy Internet in power trading and measurement aspects.

### Embodiment 1

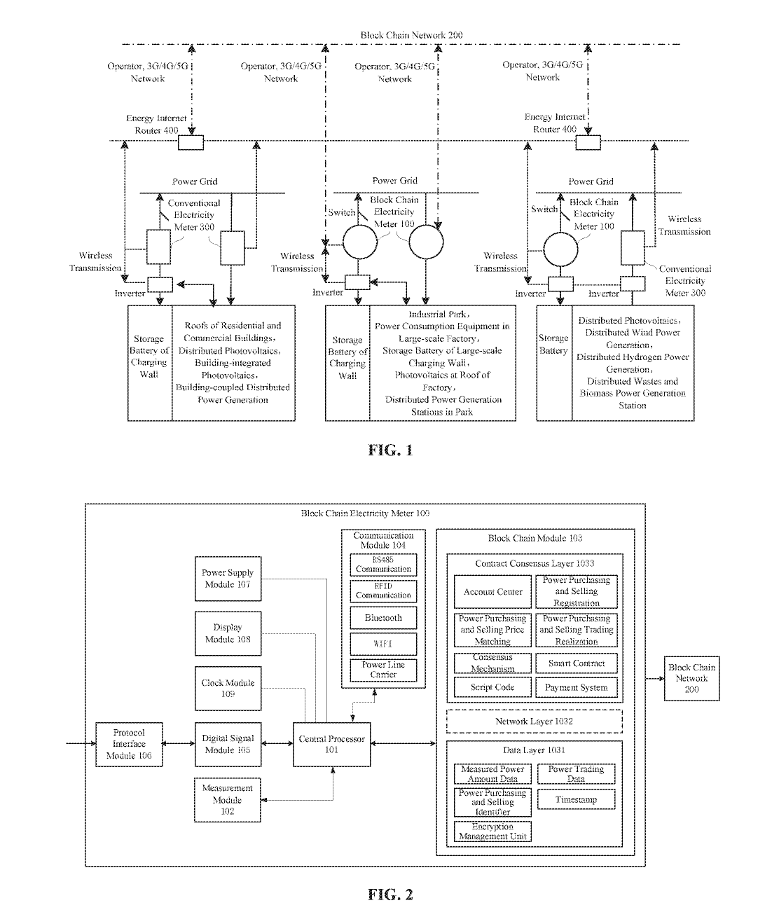

FIG. 1 is a schematic architectuue view of a power trading system provided by the present invention.

FIG. 2 is a schematic component view of a power trading system according to a first embodiment of the present invention.

Referring to FIGS. 1 and 2, the present invention provides a power trading system, comprising: a measurement module 102, a block chain module 103 and a communication module 104. The measurement module 102 is configured to bidirectionally or unidirectionally measure a power amount; the block chain module 103 uses the communication module 104 and an Internet-based block chain network 200 to realize peer-to-peer power trading among nodes within the block chain network 200 in a region; and the communication module 104 is configured to, by using the wireless or wired communication technology, transmit data between the measurement module 102 and the block chain module 103, and transmit data in the block chain network 200.

Referring to FIG. 2, in this embodiment, the power trading system further comprises a block chain power meter 100.

The measurement module 102, the block chain module 103 and the communication module 104 are arranged in block chain power meter 100.

A central processor 101 is further arranged in the block chain power meter 100 to process and calculate data in the block chain power meter 100, and control data exchange.

The measurement module 102 is connected to the central processor 101 for Bidirectional or unidirectional measurement of a power amount. The Bidirectional or unidirectional measurement here refers to measurement of a distributed power generation amount and a power storage amount as well as a power generation amount and a power consumption amount of electrical power users in two ways.

The block chain module 103 interacts with the central processor 101 in data to realize peer-to-peer power trading among nodes within the block chain network 200 in a region, measure a distributed power amount, and store trading data. The block chain module 103 is configured to realize power trading, settling and recording, so that final power amount information and the peer-to-peer power trading information are stored in the block chain network 200 in a distributed and immutable manner.

The block chain module 103 is further configured to assign each block chain power meter 100 with a unique ID to form a node with the unique ID in the block chain network 200.

Optionally, the block chain module 103 uses a digital currency for power trading or settlement, so that the power trading system is suitable for power trading or settlement in a regional power grid. The block chain module 103 can realize trading or settlement between a purchaser and a seller through the digital currency. Particularly, the block chain module 103 and an operator of a power grid can set a digital currency that is defined and circulated in this power grid to realize power trading or settlement. A power purchaser and a power seller in power purchasing and selling trading need setting a digital currency account for power trading or settlement. With the use of the digital currency, the power trading or settlement in the regional power grid is more flexible and convenient, and safer.

Optionally, the block chain network 200 is a public chain, a private chain, or an alliance chain. All or part of nodes of the public chain, the private chain or the alliance chain have complex authorities of reading, writing and keeping accounts.

Referring to FIG. 2, the block chain module 103 is provided with a data layer 1031 for storing the following data: measured power amount data, power amount trading data, a power purchasing and selling identifier, and a timestamp. The data layer is further configured to add a timestamp onto power purchasing and selling trading data in each node to form a data block which is recorded in the block chain network 200 and is immutable.

The measured power amount data is measured by the measurement module 102. Particularly, the measured power amount data refers to power amount data measured by the measurement module 102 in the block chain power meter 100.

The power amount trading data is all peer-to-peer power trading data in the block chain network 200. Particularly, the power amount trading data refers to all peer-to-peer power trading data in the block chain network 200, and the data forms a data block which is recorded in the block chain network 200 and is immutable.

The power purchasing and selling identifier is configured to distinguish a power purchaser from a power seller.

The power purchasing and selling identifier refers to a binary character string having a predetermined meaning. A first set value of the binary character string represents that a current node is the power seller. That is, this node is connected to distributed power generation equipment or a storage battery, and sells power to another node. A second set value of the binary character string represents that a current node is the power purchaser. That is, the node is connected to power consumption equipment or a storage battery, and purchases power from another node. Here, the current node may be the power seller at a moment, and will become the power purchaser at the next moment (for example, this node is connected to a rechargeable storage battery). The first set value and the second set value adopt different binary character string values to represent a power purchasing identifier or a power selling identifier, respectively.

Optionally, the binary character string may be a single digit or multiple digits.

The first set value and the second set value include but are not limited to the following definitions.

Optionally, it is defined that the first set value 0 represents that the current node is a power purchaser, and the second set value 1 represents that the current node is a power seller, and vice versa. That is, it is defined that the first set value 1 represents that the current node is the power purchaser, and the second set value 0 represents that the current node is the power seller.

Optionally, it is defined that the first set value 00 represents that the current node is a power purchaser, and the second set value 11 represents the current node is a power seller, and vice versa.

Optionally, it is defined that the first set value 01 represents that the current node is a power purchaser, and the second set value 10 represents the current node is a power seller, and vice versa.

The timestamp is configured to record the peer-to-peer power trading time in the block chain network 200. Particularly, the timestamp is configured to record the peer-to-peer power trading time in the block chain network 200, the trading time being generated through the encryption technology.

In the present embodiment, the data layer 1031 comprises an encryption management unit which encrypts data through hardware or software and which is configured to manage private key information of a user.

The data layer 1031 further comprises one or a combination of a data block, a hash, Merkle tree root data, a peer-to-peer network, key management, public and private keys, asymmetric encryption and a verification mechanism.

In the present embodiment, the block chain module 103 is further provided with a network layer 1032. The network layer 1032 comprises a P2P networking mechanism, a data transmission mechanism, a data verification mechanism and the like, so that the block chain module 1032 has an automatic networking function.

The block chain module 103 is further provided with a contract consensus layer 1033 for automatically confirming power trading between the power purchaser and the power seller within the range of the block chain network 200 through a smart contract, the power trading content comprising a power trading price, a power trading amount and a trading condition.

The contract consensus layer 1033 comprises one or a combination of an account center unit, a power purchasing and selling registration unit, a power purchasing and selling price matching unit, a power purchasing and selling trading realization unit, a consensus mechanism unit, a smart contract unit, a script code unit and a payment system unit.

In this embodiment, the communication module 104 is connected to the central processor 101, and is configured to transmit data between the measurement module 102 and the block chain module 103 and transmit data in the block chain network 200. The block chain module 103 transmits data processed by the block chain module 103 to the block chain network 200 through the communication module 104, so as to realize the peer-to-peer power trading among the nodes within the block chain network 200 in the region.

Optionally, the communication module 104 is one or a combination of an RS485 communication module, an RFID module, a Bluetooth module, a WIFI module, a power line carrier module, a 3G network module, a 4G network module, a. 5G network module and an Internet module. The present invention does not limit it. The communication module 104 may also be other pieces of communication equipment.

Optionally, wireless communication of a building side at the bottom layer adopts the radio frequency wireless transmission technology, so that the stability, security and confidentiality are more reliable, which is a technical support for guaranteeing stable operation of a charging and measuring system.

Referring to FIG. 2, in this embodiment, the block chain power meter 100 further comprises a digital signal module 105, a protocol interface module 106, a power supply module 107, a display module 108 and a clock module 109.

The digital signal module 105 is connected to the central processor 101, and is configured to collect a digital signal or an analog signal of the measurement module 102 and convert the analog signal into the digital signal.

The protocol interface module 106 is connected to the central processor 101, and is configured to manage a communication protocol interface and receive externally input data.

The power supply module 107 is connected to the central processor 101, and is configured to provide the block chain power meter 100 with a working power supply.

The display module 108 is connected to the central processor 101, and comprises a liquid crystal display screen for displaying related data. The present invention does not limit it, and the display screen may also be other types of display screens.

The clock module 109 is connected to the central processor 101 to provide the central processor 101 with an operating clock.

In the present embodiment, the components of the block chain power meter 100 in the power trading system comprise, but are not limited to the above-described components, and further comprise necessary components of a conventional power meter.

### Embodiment 2

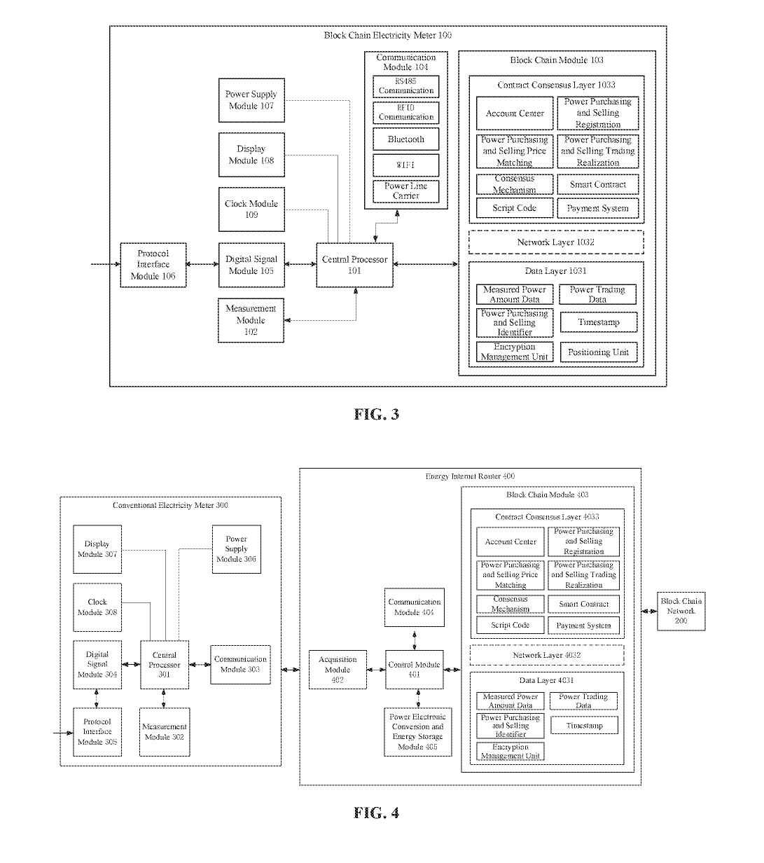

FIG. 3 is a component view of a smart power meter according to a second embodiment of the present invention.

Referring to FIG. 3, this embodiment differs from Embodiment 1 in that in this embodiment, the block chain module 103 in the block chain power meter 100 further comprises a positioning unit which is connected to the central processor 101 in the block chain power meter 100 and which is configured to position a geographical location of the block chain power meter 100.

In particular, the positioning unit in this embodiment is arranged in the data layer 1031, is connected to the central processor 101, and is configured to position the geographical location of the block chain power meter 100 to obtain geographical location information of a node in the block chain network 200. Thus, the geographical location informatization of the whole smart power grid is realized, which lays a foundation for achieving the most reasonable peer-to-peer automatic power trading in a block chain. That is, when it is prescribed in a block chain smart contract that quotations are the same, power trading between the nodes whose geographical distance is the shortest can be completed first. In this way, the electrical power transmission cost and loss are the lowest.

Optionally, the positioning unit uses a GIS (Geographic Information System) positioning chip.

Other structures, components and connection relationships of the block chain power meter 100 in this embodiment are the same as those of the block chain power meter 100 in Embodiment 1, and will not be repeated herein.

### Embodiment 3

FIG. 4 is a schematic component view of a power trading system according to a third embodiment of the present invention.

Referring to FIG. 4, the power trading system provided by the present embodiment comprises a measurement module 302, a block chain module 403 and communication modules 303 and 404. The measurement module 302 is configured to bidirectionally or unidirectionally measure a power amount. The block chain module 403 uses the communication modules 303 and 404 and an Internet-based block chain network 200 to realize peer-to-peer power trading among nodes within the block chain network 200 in a region. The communication modules 303 and 404 are configured to, by using the wireless or wired communication technology, transmit data between the measurement module 302 and the block chain module 403, and transmit data in the block chain network 200.

This embodiment differs from Embodiment 1 in that the arranged location of the block chain module 403 is different from that of the block chain module 403 in Embodiment 1.

In the present embodiment, the power trading system further comprises a conventional power meter 300 and an energy Internet router 400. The measurement module 302 and the communication module 303 are arranged in the conventional meter 300. The block chain module 403 and the communication module 404 are arranged in the energy Internet router 400.

In this embodiment, the energy Internet router 400 further comprises: a control module 401 and an acquisition module 402. The control module 401 is configured to control energy exchange between a plurality of distributed energy stations and a plurality of distributed energy users, routing management and peer-to-peer power trading within the same local area network. The acquisition module 402 is connected to the control module 401 and is configured to acquire measured power amount data of the conventional power meter 300. The block chain module 403 interacts with the control module 401 in data. The communication module 404 is connected to the control module 401.

The block chain module 403 is further configured to assign each energy Internet router 500 with a unique ID to form a node with the unique ID in the block chain network 200.

Optionally, the block chain module 403 uses a digital currency for power trading or settlement, so that the power trading system is suitable for power trading or settlement in a regional power grid. The block chain module 403 can realize trading or settlement between a purchaser and a seller through the digital currency. Particularly, the block chain module 403 and an operator of a power grid can set a digital currency that is defined and circulated in this power grid to realize power trading or settlement. A power purchaser and a power seller in power purchasing and selling trading need setting a digital currency account for power trading or settlement. With the use of the digital currency, the power trading or settlement in the regional power grid is more flexible and convenient, and safer.

Optionally, the block chain network 200 is a public chain, a private chain, or an alliance chain. All or part of nodes of the public chain, the private chain or the alliance chain have complex authorities of reading, writing and keeping accounts.

Referring to FIG. 4, in the present embodiment, the block chain module 403 is provided with a data layer 4031 for storing the following data measured power amount data, power amount trading data, a power purchasing and selling identifier, and a timestamp. The data layer is further configured to add a timestamp onto power purchasing and selling trading data in each node to form a data block which is recorded in the block chain network 200 and is immutable.

The measured power amount data is measured by the measurement module 302. Particularly, the measured power amount data refers to power amount data measured by the measurement module 302 in the conventional power meter 300.

The power amount trading data is all peer-to-peer power trading data in the block chain network 200. Particularly, the power trading data refers to all peer-to-peer power trading data in the block chain network 200, and the data forms a data block which is recorded in the block chain network 200 and is immutable.

The power purchasing and selling identifier is configured to distinguish a power purchaser from a power seller. The definition manner of the power purchasing and selling identifier in this embodiment is the same as that in Embodiment 1, and thus will not be repeated herein.

The timestamp is configured to record the peer-to-peer power trading time in the block chain network 200. Particularly, the timestamp is configured to record the peer-to-peer power trading time in the block chain network 200, the trading time being generated through the encryption technology.

In the present embodiment, the data layer 4031 comprises an encryption management unit which encrypts data through hardware or software and which is configured to manage private key information of a user.

The data layer 4031 further comprises one or a combination of a data block, a hash, Merkle tree root data, a peer-to-peer network, key management, public and private keys, asymmetric encryption and a verification mechanism.

In the present embodiment, the block chain module 403 is further provided with a network layer 4032. The network layer 4032 comprises a P2P networking mechanism, a data transmission mechanism, a data verification mechanism and the like, so that the block chain module 403 has an automatic networking function.

In the present embodiment, the block chain module 403 is further provided with a contract consensus layer 4033 for automatically confirming power trading between the power purchaser and the power seller within the range of the block chain network 200 through a smart contract, the power trading content comprising a power trading price, a power trading amount and a trading condition.

Components of the contract consensus layer 4033 here are the same as those in Embodiment 1, and thus will not be repeated herein.

In this embodiment, the conventional power meter 300 further comprises a central processor 301, a communication module 303, a digital signal module 304, a protocol interface module 305, a power supply module 306, a display module 307 and a clock module 308.

The central processor 301 is configured to process and calculate data in the conventional power meter 300, and control data exchange.

The communication interface 303 is connected to the central processor 301, and is configured to transmit data.

The digital signal module 304 is connected to the central processor 301, and is configured to collect a digital signal or an analog signal of the measurement module 302, and convert the analog signal into the digital signal.

The protocol interface module 305 is connected to the central processor 301, and is configured to manage a communication protocol interface and receive externally input data.

The power supply module 306 is connected to the central processor 301, and is configured to provide the conventional power meter 300 with a working power supply.

The display module 307 is connected to the central processor 301, and comprises a liquid crystal display screen for displaying related data. The present invention does not limit it, and the display screen may also be other types of display screens.

The clock module 308 is connected to the central processor 301 to provide the central processor 301 with an operating clock.

In the present embodiment, the components of the conventional power meter 300 comprise, but are not limited to the above-described components.

In this embodiment, the communication modules 303 and 404 are configured to transmit data between the measurement module 302 in the conventional power meter 300 and the block chain module 403 in the energy Internet router 400, and transmit data in the block chain network 200.

Optionally, the communication module 303 or 404 is one or a combination of an RS485 communication module, an RFID module, a Bluetooth module, a WIFI module, a power line carrier module, a 3G network module, a 4G network module, a 5G network module and an Internet module. The present invention does not limit it. The communication module 303 or 404 may also be other pieces of communication equipment.

Optionally, wireless communication of a building side at the bottom layer adopts the radio frequency wireless transmission technology, so that the stability, security and confidentiality are more reliable, which is a technical support for guaranteeing stable operation of a charging and measuring system.

Optionally, the conventional power meter 300 is a bidirectional power meter.

When the conventional power meter 300 is a bidirectional smart power meter, the measurement module 302 can realize Bidirectional or unidirectional measurement, so that the conventional power meter 300 can bidirectionally measure a power amount. Through the combined use of the energy Internet router 400 and the bidirectional smart power meter, the energy Internet router 400 can be not only used in energy exchange among a plurality of distributed energy networks, routing management and synergetic load consumption of wind energy, solar energy and stored energy in the same local area network, but also used to acquire measured power amount data. Thus, in the power trading system, a power generation amount and a power consumption amount of distributed power generation systems, power storage systems and electrical power users can be measured bidirectionally, and the power amount in a dispersed smart grid can be measured, traded, settled and recorded. The energy Internet router 400 at a distributed power generation side and power consumption side serve as a charge basis in trading,. Meanwhile, people can intelligently manage and monitor their own distributed power generation, storage and consumption facilities by using various mobile terminals.

Optionally, the conventional power meter 300 is a unidirectional power meter.

When the conventional power meter 300 is a traditional unidirectional power meter, the measurement module 302 in the conventional power meter 300 only measures a power consumption amount at a power consumption side. Through the combined use of the energy Internet router 400 and the conventional power meter, electrical power users at the power consumption side in the block chain network 200 can conveniently purchase power from distributed wind power energy and photovoltaic systems and storage batteries.

In the present embodiment, the components of the energy Internet router 400 in the power trading system comprise, but are not limited to the above-described components, and further comprise necessary components of a conventional energy Internet router.

### Embodiment 4

FIG. 5 is a component view of an energy Internet router according to a fourth embodiment of the present invention.

Referring to FIG. 5, this embodiment differs from Embodiment 3 in that in this embodiment, the energy Internet router 400 in the block chain module 403 further comprises a positioning unit which is connected to the control module 401 in the energy Internet router 400 and which is configured to position a geographical location of the energy Internet router 400.

In particular, the positioning unit in this embodiment is arranged in the data layer 4031, is connected to the control module 401, and is configured to position the geographical location of the energy Internet router 400 to obtain geographical location information of a node in the block chain network 200. Thus, the geographical location informatization of the whole smart power grid is realized, which lays a foundation for achieving the most reasonable peer-to-peer automatic power trading in a block chain. That is, when it is prescribed in a block chain smart contract that quotations are the same, power trading between the nodes whose geographical distance is the shortest can be completed first. In this way, the electrical power transmission cost and loss are the lowest.

Optionally, the positioning unit uses a GIS positioning chip.

Other structures, components and connection relationships of the energy Internet router 400 in this embodiment are the same as those of the energy Internet router 400 in Embodiment 3, and thus will not be repeated herein.

### Embodiment 5

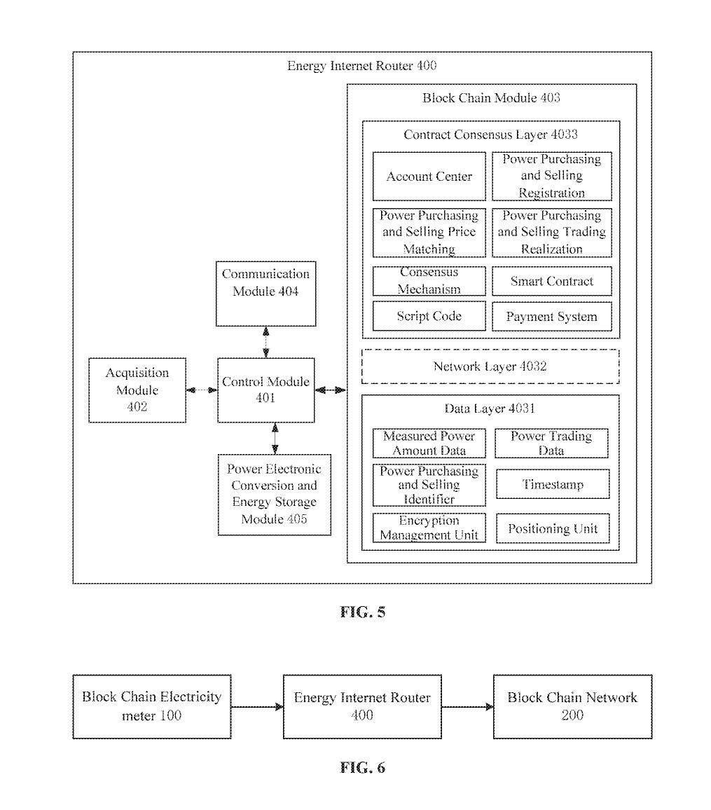

FIG. 6 is a schematic component view of a power trading system according to a fifth embodiment of the present invention.

Referring to FIG. 6, in the power trading system in this embodiment, the block chain power meter 100 transmits data to the block chain network 200 through the energy Internet router 400.

Structures, components and connection relationships of the block chain power meter 100 in this embodiment are the same as those of the block chain power meter 100 in Embodiment 1 or 2, and thus will not be repeated herein. Structures, components and connection relationships of the energy Internet router 400 in this embodiment are the same as those of the energy Internet router 400 in Embodiment 3 or 4, and thus will not be repeated herein.

In this embodiment, through the combined use of the block chain power meter 100 and the energy Internet router 400, the energy Internet router 400 is mainly used in energy exchange among source networks of a plurality of distributed energy Internet routers 400, routing management and synergetic load consumption of wind energy, solar energy and stored energy in the same local area network. The block chain power meter 100 with the block chain module 103 is configured to bidirectionally measure a power generation amount and a power consumption amount of distributed power generation systems, power storage systems and electrical power users, measure a power amount in a dispersed smart grid, realize trading in the grid, and record the trading.

In this embodiment, the energy Internet router 400 is connected to the block chain power meter 100, so that data interaction between the energy Internet router 400 and the central processor 101 in the block chain power meter 100 is realized.

### Embodiment 6

In this embodiment, the block chain network 200 is an alliance chain. In general, users included in the alliance chain are power purchasing and selling users within a coverage of a regional smart grid or a province/municipality power grid. A rewiring authorization and an account keeping participation authorization on the alliance chain are regulated based on organization rules of the block chain network 200 in the regional power grid. Contents of data disclosed to nodes having different authorization levels in the regional power grid are different.

### Embodiment 7

In this embodiment, the block chain network 200 is a private chain. In general, users included in the private chain are power purchasing and selling users within a coverage of a regional smart grid. A rewiring authorization and an account keeping participation authorization on the alliance chain are regulated based on organization rules of the block chain network 200 in the regional power grid. Data is only disclosed to nodes within the regional power grid, rather than the general public.

The present invention aims to protect a power trading system. By providing the block chain module for power trading, settling and recording, final power amount information and peer-to-peer power trading information can be stored in the block chain network in a distributed and immutable manner. Through the power trading system provided by the present invention, a power generation amount and a power consumption amount of distributed power generation systems, power storage systems and electrical power users can be measured, so that the power amount in a dispersed smart grid can be measured, traded, settled and recorded. The block chain power meter or the conventional power meter at a distributed power generation side and power consumption side serve as a charge basis in trading. Meanwhile, people can intelligently manage and monitor their own distributed power generation, storage and consumption facilities by using various mobile terminals. Therefore, the power trading system provided by the present invention will have a broader market space and will surely become a major provider for big data in the future energy Internet.

It should be understood that the above specific embodiments of the present invention are only used to illustratively describe or explain the principle of the present invention, and are not intended to limit the present invention. Therefore, any modifications, equivalent replacements, improvements and the like made without departing from the spirit and the scope of the present invention shall be included in the protection scope of the present invention. Moreover, the appended claims of the present invention are intended to cover all changes and modifications that fall within the scope and the borderline of the appended claims or the equivalents of such scopes and boundaries.

What is claimed is:

1. A power trading system, comprising:
a measurement module, a block chain module and a communication module, wherein the measurement module is configured to bidirectionally or unidirectionally measure a power amount;
the block chain module uses the communication module and an Internet-based block chain network to realize peer-to-peer power trading among nodes within the block chain network in a region; and
the communication module is configured to, by using the wireless or wired communication technology, transmit data between the measurement module and the block chain module, and transmit data in the block chain network.

2. The power trading system of claim 1, further comprising:
a block chain power meter, wherein
the measurement module, the block chain module and the communication module are arranged in the block chain power meter;
a central processor is further arranged in the block chain power meter;
the measurement module is connected to the central processor;
the block chain module interacts with the central processor in data; and
the communication module is connected to the central processor, and is configured to transmit data between the measurement module and the block chain module and transmit data in the block chain network.

3. The power trading system of claim 2, wherein the block chain module further comprises:
a positioning unit which is connected to the central processor in the block chain power meter and is configured to position a geographical location of the block chain power meter.

4. The power trading system of claim 2, wherein
the block chain module is further configured to assign each block chain power meter with a unique ID to form a node with the unique ID in the block chain network.

5. The power trading system of claim 1, further comprising:
a conventional power meter and an energy Internet router, wherein
the measurement module and the communication module are arranged in the conventional power meter;
the block chain module and the communication module are arranged in the energy Internet router; and
the communication modules are configured to transmit data between the measurement module in the conventional power meter and the block chain module in the energy Internet router, and transmit data in the block chain network.

6. The power trading system of claim 5, wherein the energy Internet router further comprises:
a control module configured to control energy exchange between a plurality of distributed energy stations and a plurality of distributed energy users, routing management and peer-to-peer power trading within the same local area network; and
an acquisition module connected to the control module and configured to acquire measured power amount data of the conventional power meter, wherein
the block chain module interacts with the control module in data; and
the communication module is connected to the control module.

7. The power trading system of claim 6, wherein the block chain module further comprises:
a positioning unit which is connected to the control module in the energy Internet router and is configured to position a geographical location of the energy Internet router.

8. The power trading system of claim 5, wherein
the block chain module is further configured to assign each energy Internet router with a unique ID to form a node with the unique ID in the block chain network.

9. The power trading system of claim 1, wherein
the block chain module is provided with a data layer for storing the following data:
measured power amount data measured by the measurement module;
power amount trading and settling data which is all peer-to-peer power trading data in the block chain network;
a power purchasing and selling identifier which is configured to distinguish a power purchaser from a power seller; and
a timestamp for recording peer-to-peer power trading and settling time in the block chain network, wherein
the data layer is further configured to add a timestamp onto power purchasing and selling trading data in each node to form a data block which is recorded in the block chain network and is immutable.

10. The power trading system of claim 9, wherein
the power purchasing and selling identifier refers to a binary character string having a predetermined meaning;
a first set value of the binary character string represents that a current node is the power seller; and a second set value of the binary character string represents that a current node is the power purchaser.

11. The power trading system of claim 9, wherein
the data layer comprises an encryption management unit which encrypts data through hardware or software and which is configured to manage private key information of a user; and
the data layer further comprises one or a combination of a data block, a hash, Merkle tree root data, a peer-to-peer network, key management, public and private keys, asymmetric encryption and a verification mechanism.

12. The power trading system of claim 9, wherein
the block chain module is further provided with a contract consensus layer for automatically confirming power trading between the power purchaser and the power seller within the range of the block chain network through a smart contract, the power trading content comprising a power trading price, a power trading amount and a trading condition, according to which, Payment System starts the paying and charging function of digital currency.

13. The power trading system of claim 12, wherein
the contract consensus layer comprises one or a combination of an account center unit, a power purchasing and selling registration unit, a power purchasing and selling price matching unit, a power purchasing and selling trading realization unit, a consensus mechanism unit, a smart contract unit, a script code unit and a payment system unit.

14. The power trading system of claim 1, wherein
the block chain module uses a digital currency for power trading or settlement.

15. The power trading system of claim 1, wherein
the block chain network is a public chain, a private chain, or an alliance chain; and
all or part of nodes of the public chain, the private chain or the alliance chain have complex authorities of reading, writing and keeping accounts.

16. The power trading system of claim 1, wherein
the communication module is one or a combination of an RS485 communication module, an RFID module, a Bluetooth module, a WIFI module, a power line carrier module, a 3G network module, a 4G network module, a 5G network module and an Internet module.
